(19) United States
(12) Patent Application Publication
(10) Pub. No.: US 2009/0178062 A1
(43) Pub. Date: Jul. 9, 2009

(54) Framework and Methods for Providing Communication Services to Client Applications

(75) Inventor: Peter Westen, Mountain View, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/135,927

(22) Filed: Jun. 9, 2008

Related U.S. Application Data
(60) Provisional application No. 60/943,013, filed on Jun. 8, 2007.

(51) Int. Cl. G06F 3/00

(52) U.S. Cl. 719/328

(57) ABSTRACT

The disclosed implementations provide an infrastructure and methods for providing communication services to an application through an Application Programming Interface (API).

### RELATED APPLICATIONS

This patent application claims the benefit of priority from pending U.S. Provisional Patent Application No. 60/943,013, entitled “Framework and Methods for Providing Communication Services to Client Applications,” filed Jun. 8, 2007, which provisional patent application is incorporated by reference herein in its entirety.

### TECHNICAL FIELD

The subject matter of this application is generally related to electronic communication systems.

### BACKGROUND

Electronic communications systems (e.g., videoconferencing systems) allow users to communicate with each other electronically over one or more communication channels (e.g., the Internet, Ethernet, wireless networks, telephone lines). Conventional electronic communication systems are often implemented as standalone applications that are hosted on a device (e.g., a personal computer, mobile or smart phone, media/player recorder, game console, persona digital assistant, navigation system). It is often desirable to integrate communication functionality with other applications on the same device. For example, it may be desirable to share documents or content created in an application (e.g., a presentation application) with participants of a videoconference session. Unfortunately, developing code for integrating communication functionality into applications can be costly and time consuming.

### SUMMARY

The disclosed implementations provide an infrastructure and methods for providing communication services to an application through an Application Programming Interface (API).

Particular embodiments of the subject matter described in this specification can be implemented to realize one or more of the following advantages. A framework is provided for leveraging and extending service provided by a electronic communication system.

The details of one or more embodiments of the invention are set forth in the accompanying drawings and the description below. Other features, aspects, and advantages of the invention will become apparent from the description, the drawings, and the claims.

### DESCRIPTION OF DRAWINGS

FIG. 1 is a screenshot of a contact list in an electronic communication environment.

FIG. 2 is a screenshot of a video chat application including text messaging and videoconferencing sessions.

FIG. 3 is a diagram of content sharing in a video chat application.

FIG. 4 is a flow diagram of example steps for setting a video data source using a communication framework.

FIG. 5 is a block diagram of an example system architecture.

### DETAILED DESCRIPTION

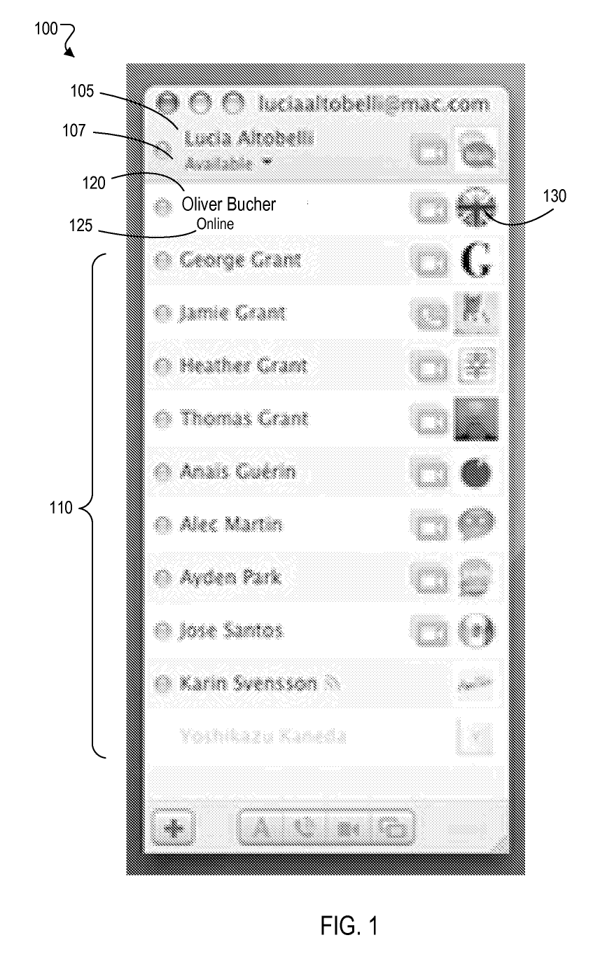

The examples that follow will often refer to the iChat™ application distributed by Apple Inc., as part of Mac OS™. The disclosed implementations, however, also apply to other types of communication applications and operating systems (e.g., Windows®, Linux). FIGS. 1-3 below are used to illustrate the use of various types of communications services, which can be provided by an electronic communication infrastructure or framework through an Application Programming Interface (API).

### Examples of Communication Services Used by Applications

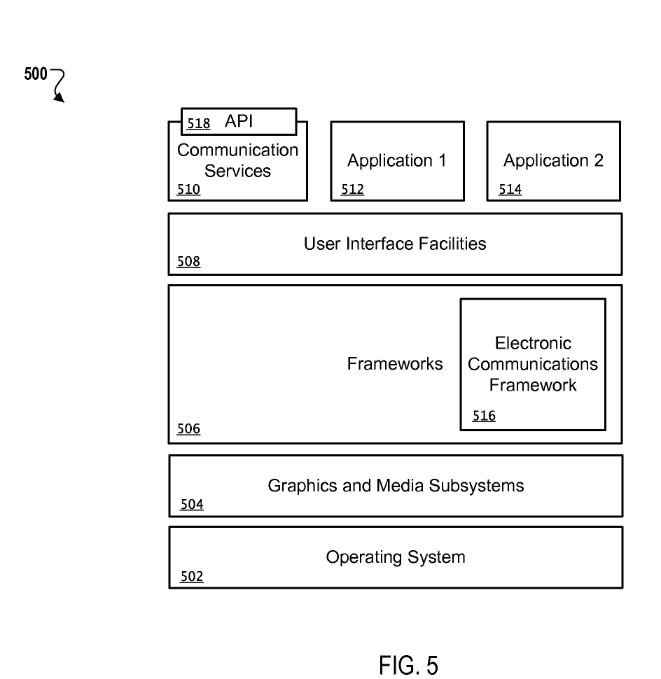

FIG. 1 is a screenshot of a contact list dialog 100 provided by a communication service to an application. The service can be provided through an API, which an application developer can use to request and receive communication services and information that can be used within the application. Examples of applications include but are not limited to: video conferencing, presentation applications (e.g., Keynote™, PowerPoint™), email, navigation/mapping application, etc. In some implementations, the API provides access to code or libraries residing in lower layers of a software stack of an operating system, such as described in reference to FIG. 5. An example software stack is the Mac OS™ software stack, developed by Apple Inc.

In some implementations, a contact list dialog 100 includes a contact list 110 including one or more contacts (e.g., individuals or entities) that can participate in a communication session using communication services, provided by an operating system through an API, for example. Typically, each contact represented in the contact list 110 has agreed to receive such request from the user. When communication with a contact is requested by a user, the request can be transmitted to a communication system operated by the contact (e.g., a personal computer, smart phone). The contact can accept or deny the request and, in the case of acceptance, engage in communication with the user. The communication can include text, voice, video, or any other known forms of communication.

A contact represented in the contact list 110 can include descriptive information associated with the contact. This information can be presented with the contact in the contact list 110. For example, the representation of a contact can include a name identifier 120 for the contact. The name identifier can correspond to a real name (e.g., first and last name), username, login name, user-defined name, email address or other alias by which the contact can be recognized. The representation of the contact can also include a status indicator 125. The status indicator 125 can present information associated with the contact's availability to communicate with the user. The status indicator 125 can, for example, be one of a number of predefined status indicators (e.g., busy, away, idle, at lunch, etc.). The representation of the contact in the contact list 110 can include a visual object 130 (e.g., an icon) associated with the contact. The visual object 130 can be selected by a user to initiate a communication session with a contact.

The contact list dialog 100 can also include information about the user of the communication system, including a name identifier 105 associated with the user and a status indicator 107 to indicate the availability of the user to engage in a communication session with a contact. Generally, the contact list dialog 100 is interactive allowing a user to operate the communication system. For example, the status indicator 107 can be operable to select or specify a status value for the user. Each contact in the contact list 110 can be selectable so that a user can invoke a request to communicate with a selected contact.

As previously described, communication services can be accessed by applications or clients residing on a single device using a communication services API. Services provided through the API can store information about an account on a network server, such as information about the status of the user and the user's contacts or buddies. This same information can be accessed by other applications using the communication services. The communication services can retrieve screen names and login status of contacts or buddies.

### Combined Text Messaging & Video Chat Application

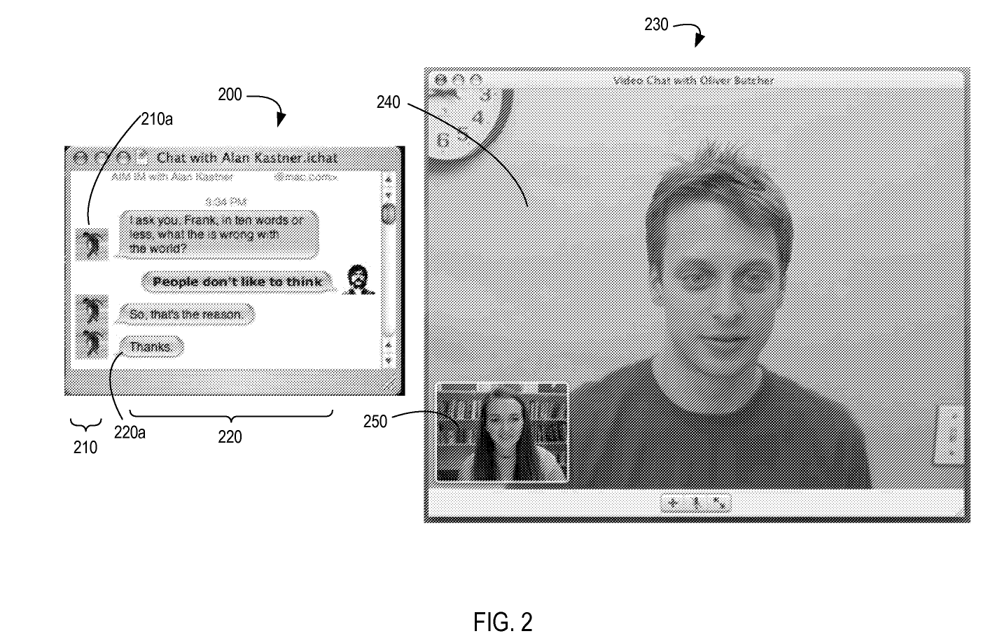

FIG. 2 is a screenshot of a video chat application including a text messaging session 200 and a video conferencing session 230. The application can include any number of text and/or video messaging sessions, or can also include other types of electronic communications.

In some implementations, the text messaging session 200 includes contact images 210 representing a user's contacts engaged in text message sessions. For example, the first contact is represented by contact image 210a. The session also includes text bubbles 220, each of which is in proximity to a contact image 210. Each of the text bubbles 220 includes a portion of a text message sent by a participant of the session. The text can be the entire message, the initial part of the message, or a summary of the message. For example, the text bubble 220a contains the text “Thanks.” which may be, for example, the entire text message.

In some implementations, the video messaging session 230 includes a contact video area 240 and a user video area 250. The contact video area 240 can display a live video feed of the user's contact (e.g., the young man depicted in FIG. 2). In some implementations, the user video area 250 can be smaller than (and embedded within) the area 240 and can be used, for example, to display the user's video image. In some implementations, additional video areas may be used, such as that used in a three-way video conference that may include, for example, an additional contact video area 240 corresponding to the second of two contacts to which the user is communicating.

### Content Sharing Application

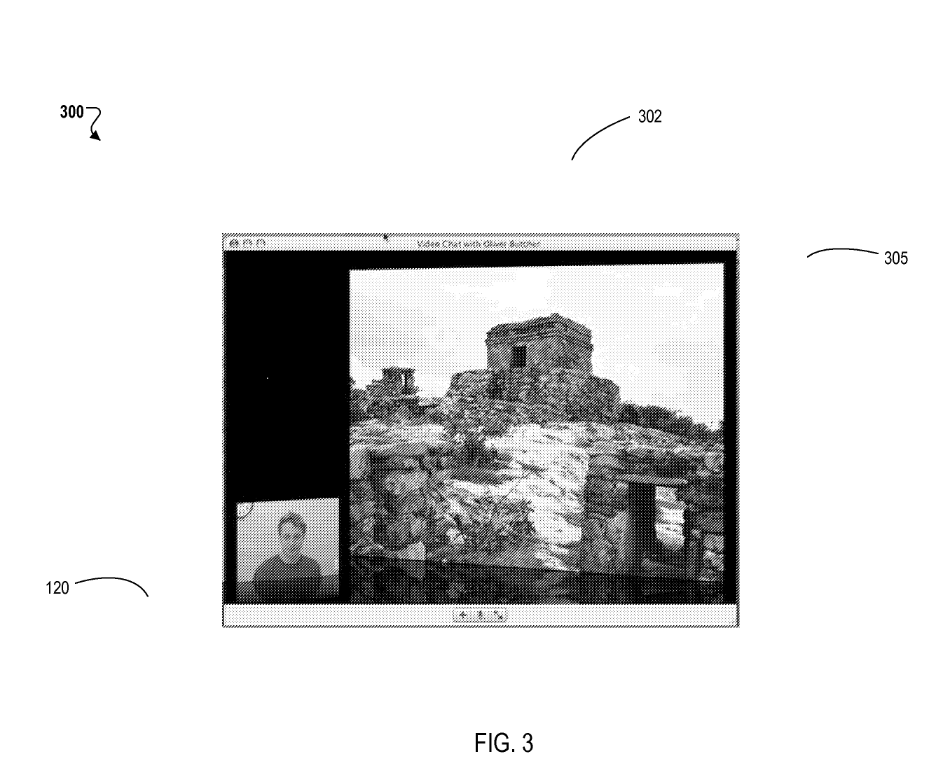

FIG. 3 is a diagram of a content sharing screen 300 in a video chat application. In the example shown, the content sharing screen 300 includes a video conferencing portion that displays a contact image for the contact 120 (FIG. 1). The title bar 302 identifies the contact 120 participating in the session as Oliver Butcher. For example, the content sharing screen 300 may be accessible by selecting the contact 120 on the list of contacts 110.

In some implementations, the content sharing screen 300 can be used to share various types of content, including: text documents, images, photos, Keynote™ or PowerPoint™ presentations, spreadsheets, .pdfs or any such displayable content that a user may desire to share with a contact. Sharable content may include any visual content that can be rendered, for example, on a graphical user interface (GUI). Generally, the GUI is presented on a screen such as a home computer, television, laptop, cell phone, personal digital assistant (PDA), game console or any such electronic device capable of displaying information. Sharable content may include one or more audible components in addition to one or more visual components.

### Example Communications Infrastructure/Framework and API

The applications represented by the graphical displays depicted in FIGS. 1-3 can be created using communication services provided by electronic communications framework of a software protocol stack. The framework may be accessible using an API. In the following description a client application is used to refer to any entity making use of the framework by way of the API. In the examples that follow, an infrastructure and framework for providing communication services will be described with frequent references to the iChat™ video chat application.

### Getting User Status

In some implementations, a communications framework (e.g., an IM framework) can be used to check the status of a particular contact. For example, a check can be made to determined whether the contact is available and then to display an appropriate icon or other graphical representation in a client application. The API can specify various classes and objects in an object oriented programming (OOP) model (e.g., Objective-C classes, objects, methods). For example, the following code fragment uses an imageNameForStatus: class method to identify a status image based on a contact's status:

NSString *message;
switch ([IMService myStatus]){
case IMPersonStatusUnknown:
message = @“Unknown”;
break;
case IMPersonStatusOffline:
message = @“Offline”;
break;
case IMPersonStatusIdle:
message = @“Idle”;
break;
case IMPersonStatusAway:
message = @“Away”;
break;
case IMPersonStatusAvailable:
message = @“Available”;
break;
}

A myIdleTime class method can be used to get the idle time of a contact.

### Getting Status of Services

In some implementations, any given user may have multiple accounts on multiple services—for example, have both a .mac and Jabber account on a computer running Mac OS. The system can use an allServices class method to get an array of the services or a serviceWithName: class method to get a specific service. For example, this code fragment iterates through each instant message service:

NSEnumerator *serviceEnumerator = [[IMService allServices]
objectEnumerator];
IMService *imservice;
while (imservice = [serviceEnumerator nextObject]){
...
}

Once a user has an IMService object, a user can access information about the service using a number of methods. For example, a user can use either a localizedName or a localizedShortName method to display a human-readable name of a service. For example, the name of a network service (e.g., .mac) might be AIM whereas the localized name might be AOL Instant Messenger. In contrast, the string returned by the name method is not localized and should only be used in a later call to the serviceWithName: method.

In some implementations, a user can also check the status of the service itself to determine if the user is logged in or not. Note that a myStatus method can return IMPersonStatusOffline unless the user is logged into a service.

This example code fragment creates a human-readable message describing service status:

NSString *message;
switch ([service status]){
case IMServiceStatusLoggedOut:
message = @“Logged Out”;
break;
case IMServiceStatusDisconnected:
message = @“Disconnected”;
break;
case IMServiceStatusLoggingOut:
message = @“Logging Out”;
break;
case IMServiceStatusLoggingIn:
message = @“Logging In”;
break;
case IMServiceStatusLoggedIn:
message = @“Logged In”;
break;
}

### Accessing Contacts

To access contacts, in some implementations a user can get a list of all the user's contacts and individual information about each one. A user can obtain the contact list using an infoForAllScreenNames method. This method returns an array of dictionaries where each dictionary contains key-value pairs that describe a contact. For example, this example code fragment prints the screen name for each contact using the IMPersonScreenNameKey key.

NSEnumerator *accountEnumerator = [[service infoForAllScreenNames]
objectEnumerator];
NSDictionary *accountInfo;
while (accountInfo = [accountEnumerator nextObject]){
/ / Print the account screenname
NSLog(@“Buddy with screenname=%@”,
[accountInfo objectForKey:IMPersonScreenNameKey]);
}

Other properties of a contact (or buddy) are first name, last name, email address, idle time, busy message, and picture data if available. A user can also display an image for the status using the imageNameForStatus: class method described above.

A chat room (e.g., iChat™ Theater) allows applications to send additional audio and video tracks during an audio/video (AV) chat. The application can provide the auxiliary video through periodic callbacks for individual frames. Audio is provided through an audio device and channels.

Before implementing a video source, a user can typically select the buffer type—a pixel buffer or an OpenGL buffer—that is most efficiently filled by a user's application during a callback. The pixel buffer is filled in the main memory—by the CPU rather than the GPU. If a user is rendering content using OpenGL, then a user can typically use the OpenGL buffer.

There can be several steps involved in using a chat room (e.g., iChat Theater) in a user's application. The steps can include: 1) setting a video data source and any video options; 2) implementing a user's video data source; if a user is using pixel buffers, implement the pixel buffer methods using video services provided by, for example, an operating system (e.g., Core Video in Mac OS). If a user is using OpenGL, implement the OpenGL methods; 3) creating audio channels and managing the channels using an audio service (e.g., Core Audio in Mac OS); 4) using start and stop methods to control video playback; and 5) registering for state change notifications.

### Getting the Manager

The first step in using a chat room like iChat™ Theater, for example, is to get a shared manager object that controls auxiliary audio and video playback. A sharedAVManager class method returns the shared IMAVManager object. This example code fragment gets the state of the shared IMAVManager object:

IMAVManagerState state=[[IMAVManager sharedAVManager] state];

### Setting the Video Data Source

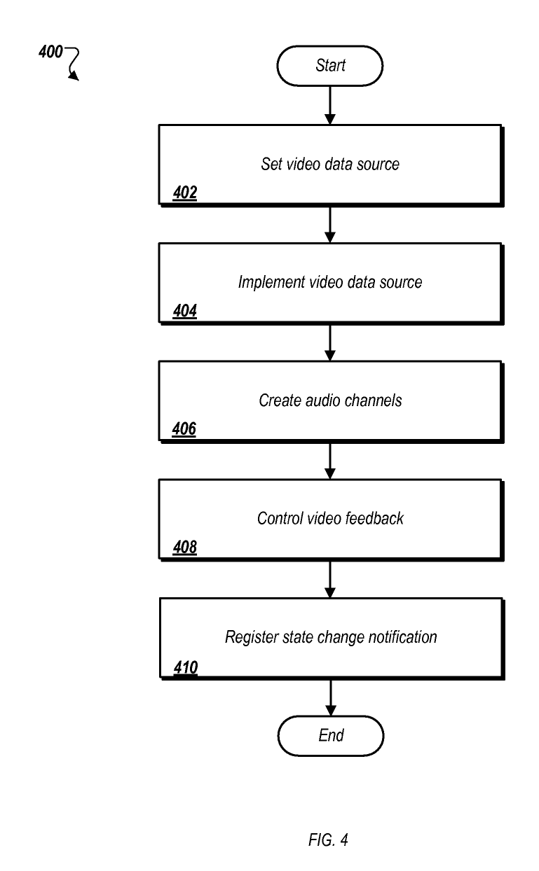

FIG. 4 is a flow diagram of example process for setting a video data source using a communication framework. In step 402, a video data source is set. For example, the application can provide auxiliary video content that is sent over to a videoconferencing session. This can be accomplished using a delegation model. A user can set a video data source object that conforms to a defined protocol and an Instant Message framework sends a message to the data source object when it needs the next video frame. Hence, messages are sent periodically to a user's video data source object during playback.

For example, this code fragment sets the video data source for a shared IMAVManager object using a setVideoDataSource: method, then sets some optimization options using a setVideoOptimizationOptions: method, and starts video playback using a start method:

IMAVManager *avManager = [IMAVManager sharedAVManager];
[avManager setVideoDataSource:videoDataSource];
[avManager setVideoOptimizationOptions:IMVideoOptimizationStills];
[avManager start];

The setVideoOptimizationOptions method can be used to give hints to an IMAVManager object so it can optimize playback based on a type of video source. For example, an IMVideoOptimizationStills option can be used for sharing a slideshow.

### Implementing the Video Data Source

In step 404, the video data source is implemented. For example, the video data source may conform to the IMVideoDataSource informal protocol. A user can select the type of buffer that is most efficient for a user's application. If a user is using pixel buffers, then implement a getPixelBufferPixelFormat: and renderIntoPixelBuffer:forTime: methods. If a user is using OpenGL, then implement a getOpenGLBufferContext:pixelFormat:

and

renderIntoOpenGLBuffer:onScreen:forTime:methods.

For performance reasons, all of these callbacks need not be invoked on a main thread. If a user is using OpenGL, which may not be thread-safe, to render to both the screen and buffer, then a user may need to take some extra precautions. OpenGL can be used a multithreaded application.

### Creating Audio Channels

In step 406, audio channels are created. For example, the audio tracks may not be not handled the same way as the video tracks. A user can set the number of audio channels before playing any AV using the setNumberOfAudioChannels: method. The audio can either be mono or stereo. A user can access the audio device and channels using the audioDeviceUID and audioDeviceChannels methods respectively. Use these methods when the shared IMAVManager is in the IMAVRunning state; otherwise, they return nil. Use Core Audio to manage the channels and create audio content.

Referring to the following listing, a user can also play any NSSound over iChat Theater using the setPlaybackDeviceIdentifier: and setChannelMapping: methods of NSSound. The playMonoForiChat: method is intended to be a category method that a user can add to NSSound. If the sound is mono use the playStereoForiChat: method instead of the play method of NSSound to play the sound over iChat Theater. There's a similar category method in the sample code if the sound is stereo.

Listing 1 Playing sounds over iChat Theater

- (BOOL) playMonoForiChat:(BOOL)flag {
if (flag) {
// Set the audio output device.
IMAVManager *avManager = [IMAVManager sharedAVManager];
[self setPlaybackDeviceIdentifier:[avManager audioDeviceUID]];
// Get the channel info for iChat Theater.
NSArray *channels = [avManager audioDeviceChannels];
NSUInteger channelCount = [channels count];
// For a mono sound, map its single channel to those of the IMAVManager
NSArray *mapping = (channelCount > 0) ? [NSArray
arrayWithObject:channels]
: nil;
[self setChannelMapping:mapping];
} else {
// Use default playback device and channel mapping.
[self setPlaybackDeviceIdentifier:nil];
[self setChannelMapping:nil];
}
return [self play];
}

### Controlling Video Playback

In step 408, video feedback is controlled. For example, after the user sets the video data source and create a user's audio channels, a user is ready to start playing AV content in iChat. A user can simply send start to the shared IMAVManager object to play, and stop to stop the AV content. The IMAVManager object transitions through several states during playback.

When a user sends start to a stopped IMAVManager object, it changes state from IMAVStopped to IMAVStartingUp, then to IMAVPending, and finally to IMAVRunning. When a user invokes the start method, the state changes immediately to IMAVStartingUp and the method returns. The IMAVManager object asynchronously transitions to the other states.

Because IMAVManager implements a state machine, the order in which a user can invoke methods is important. Although, sending start to an IMAVManager object that is not stopped does nothing, sending one of the setVideo . . . methods to an IMAVManager while it is running raises exceptions.

Conversely, when a user sends stop to a running IMAVManager object, it changes state from IMAVRunning, to IMAVShuttingDown, and then to IMAVStopped. When a user invokes the stop method, the state changes immediately to IMAVShuttingDown and the method returns. The IMAVManager object asynchronously transitions to IMAVStopped. The stop method returns immediately if the IMAVManager object is not in the IMAVRunning state.

### Registering for the State Change Notification

In step 410, the system registers for the state change notification. For example, when using the iChat Theater API, the IMAVManager object can be in a number of different states at anytime—for example, depending on whether or not a user can invoke the start or stop method. Even after invoking these methods, the state of the IMAVManager object is not guaranteed because errors can occur while transitioning from a stopped to a running state or another application using the iChat Theater API can cause state transitions a user might not expect. Invoking other methods while IMAVManager is not in an expected state can raise exceptions or do nothing. Besides checking the state using the state method, a user can track the state of the shared IMAVManager object by observing the IMAVManagerStateChangedNotification notification.

### Using Pixel Buffers

There are methods that video data source objects can implement to use pixel buffers for iChat Theater.

### Getting the Video Format

A user's video data source object may need to implement the getPixelBufferPixelFormat: IMVideoDataSource protocol method to return the pixel format for the video content. The IMAVManager object may need this information to properly display and transmit the video. This getPixelBufferPixelFormat: implementation returns the kCVPixelFormatType_{—}32ARGB pixel format appropriate for Core Video pixel buffers, from which graphics contexts are derived, as shown:

- (void)getPixelBufferPixelFormat:(OSType *)pixelFormatOut {
*pixelFormatOut = kCVPixelFormatType_32ARGB;
}

The pixel format returned by this method is the format of the CVPixelBufferRef object that is passed to the renderIntoPixelBuffer:forTime: IMVideoDataSource protocol method.

### Rendering Video Frames

A user's video data source may need to implement the renderIntoPixelBuffer:forTime: IMVideoDataSource protocol method to provide the next frame in the video content. The sample code described herein, for example, uses Core Video.

If the video frame has not changed since the last frame—for example, in a slideshow the same frame is displayed for several seconds-then the renderIntoPixelBuffer:forTime: method should return NO so that transmitting frames can be more efficient. This code fragment locks the pixel buffer using the CVPixelBufferLockBaseAddress function:

// Lock the pixel buffer's base address so that we can draw into it.
if((err = CVPixelBufferLockBaseAddress(buffer, 0)) !=
kCVReturnSuccess) {
// Rarely is a lock refused. Return NO if this happens.
NSLog(@“Warning: could not lock pixel buffer base address in
%s - error
%Id”, _func_, (long)err);
return NO;
}

The pixel buffer dimensions can change from one frame to the next so always obtain the dimensions from the pixel buffer argument—do not use the previous dimensions. This code fragment creates a graphics context from the pixel buffer:

size_t width = CVPixelBufferGetWidth(buffer);
size_t height = CVPixelBufferGetHeight(buffer);
CGColorSpaceRef colorSpace = CGColorSpaceCreateDeviceRGB( );
CGContextRef cgContext =
CGBitmapContextCreate(CVPixelBufferGetBaseAddress(buffer),
width, height,
8,
CVPixelBufferGetBytesPerRow(buffer),
colorSpace,
kCGImageAlphaPremultipliedFirst);
CGColorSpaceRelease(colorSpace);

If a user is creating the video content using Cocoa drawing methods, a user can create an NSGraphicsContext, make it current, and invoke the drawing methods—for example, the drawInRect:fromRect:operation:fraction: NSImage method or the drawAtPoint: NSAttributedString method—to render the next frame in the pixel buffer as shown here:

NSGraphicsContext*context = [NSGraphicsContext
graphicsContextWithGraphicsPort:cgContext flipped:NO];
[NSGraphicsContext setCurrentContext:context];
// Insert drawing methods here
[context flushGraphics];

Finally, a user may need to release all objects and unlock the pixel buffer as shown here:

CGContextRelease(cgContext);
CVPixelBufferUnlockBaseAddress(buffer, 0);

### Using OpenGL Buffers

The following describes the methods that a user's video data source object may need to implement to use OpenGL for iChat Theater.

### Getting the Video Format

A user's video data source object may need to implement the getOpenGLBufferContext:pixelFormat: IMVideoDataSource protocol method to return the OpenGL context and pixel format for the video content. The IMAVManager object may need this information to properly display and transmit the video.

- (void)getOpenGLBufferContext:(CGLContextObj *)contextOut
pixelFormat:(CGLPixelFormatObj *)pixelFormatOut {
*contextOut = context;
*pixelFormatOut = pixelFormat;
}

Typically, the context and pixel format objects are created and retained by the video data source object in the designated initializer. This code fragment creates an OpenGL context and pixel format object:

long npix = 0;
CGLPixelFormatAttribute attributes[ ] = {
kCGLPFADoubleBuffer,
kCGLPFAColorSize, 24,
0
};
CGLChoosePixelFormat(attributes, &pixelFormat, (void*)&npix);
CGLCreateContext(pixelFormat, [[self openGLContext] CGLContextObj],
&context);

### Rendering Video Frames

A user's video data source object may need to implement the renderIntoOpenGLBuffer:onScreen:forTime: IMVideoDataSource protocol method to render the OpenGL content into the buffer. The Instant Message framework specifies the screen when invoking the renderIntoOpenGLBuffer:onScreen:forTime:method so it can be more efficient when the computer has multiple graphics cards.

Note that OpenGL is not thread-safe so if a user is rendering to the display and the buffer at the same time, a user may need to use the OpenGL macros to render in two different contexts—the default context for the display and an alternate context for the buffer—as described in Improving Performance in OpenGL Programming Guide for Mac OS X.

This implementation of the renderIntoOpenGLBuffer:onScreen:forTime: method in an NSView subclass uses the OpenGL macros to render into the passed OpenGL buffer using an alternate context:

- (BOOL) renderIntoOpenGLBuffer:(CVOpenGLBufferRef)buffer
onScreen:(int
*)screenInOut forTime:(CVTimeStamp*)timeStamp {
// We ignore the timestamp, signifying that we're providing content for
‘now’.
// Make sure we agree on the screen ID.
CGLContextObj cgl_ctx = _alternateContext;
CGLGetVirtualScreen(cgl_ctx, screenInOut);
// Attach the OpenGLBuffer and render into the _alternateContext.
if (CVOpenGLBufferAttach(buffer, _alternateContext, 0, 0,
*screenInOut) ==
kCVReturnSuccess) {
// In case the buffers have changed in size, reset the viewport.
CGRect cleanRect = CVImageBufferGetCleanRect(buffer);
glViewport(CGRectGetMinX(cleanRect), CGRectGetMinY(cleanRect),
CGRectGetWidth(cleanRect), CGRectGetHeight(cleanRect));
// Render
[self _renderInContext:_alternateContext];
return YES;
} else {
// This should never happen. The safest thing to do if it does is return
// ‘NO’ (signifying that the frame has not changed).
return NO;
}

The _renderInContext: method in the sample code does the actual rendering using the supplied context and is also invoked by the drawRect: method as shown in this code fragment:

- (void) _renderInContext:(CGLContextObj)cgl_ctx {
glClearColor(0.0, 0.0, 0.0, 1.0);
glClear(GL_COLOR_BUFFER_BIT);
/* ... */
}
- (void) drawRect:(NSRect)rect {
// Render in the normal context.

### Using Views as Video Data Sources

Any NSView object can also be a video data source of an IMAVManager object. This includes instances of the WebView, NSOpenGLView, QCView, and QTMovieView classes. For example, a user can implement a simple web browser using theWeb Kit and send the rendered pages to iChat Theater. The Instant Message framework adds video rendering capabilities to these classes.

### Setting the Video Data Source

It's very simple to set an NSView object as a video data source. Just create an instance of the view a user wants to render as an auxiliary video source in iChat Theater and set the shared IMAVManager object's video data source to the view as in this code fragment:

[[IMAVManager sharedAVManager] setVideoDataSource:myWebView];

### Setting Video Options

By default, the Instant Message framework uses full-motion video for views. A user can change this behavior and improve performance by setting the video optimization options for arbitrary views to stills. If the user sets the video optimization to IMVideoOptimizationStills using the setVideoOptimizationOptions: method, a user may need to tell the Instant Message framework when to request the next frame. If a user sends setNeedsDisplay: or setNeedsDisplayInRect: to an NSView object, passing YES as the parameter, then the Instant Message framework requests the next frame. A user may not need to set the optimization options for a QTMovieView object.

### Subclassing NSView

A user can create a subclass of NSViewthat does not use the default rendering implementation provided by the Instant Message framework. A user can do this by simply implementing the IMVideoDataSource protocol. The Instant Message framework uses the NSViewsubclass implementation of the IMVideoDataSource rendering methods if they exist.

### Introduction to the Instant Message Framework

A user can use the Instant Message framework to access iChat information and provide an auxiliary video source to iChat Theater.

The IMService class provides a way to integrate a variety of data about a user's iChat connections into the user's application. It provides information on which services the user is connected to (for example, AIM or Bonjour) their online screen names, their contacts, their current status on a given service (away, idle, available), idle times, and other presence-specific details. The API also provides notifications to update a user's applications when a user's status, information, status images, or service connections have changed. A variety of status notifications related to the user's status and preferences are posted by the IMService custom notification center.

The IMAVManager class allows a user to create auxiliary video and audio sources that are played back through iChat AV during active chats. This is a mechanism for users to share other video sources with contacts. The IMAVManager class uses a delegation model in which a user can implement a video data source that provides each video frame via a callback message. A user can implement a user's video source using either Core Video or OpenGL. A user can use Core Audio to handle audio channels. After setting up the audio and video sources, a user can begin playback by simply sending a start message to the shared IMAVManager object.

The Instant Message framework can be used only by an Objective-C Cocoa application.

### IMAVManager Class Reference

The IMAVManager class is used to manage the state and configuration of auxiliary audio/video input to iChat AV—a feature that is called iChat Theater. There is only one shared instance of the IMAVManager class. The IMAVManager shared object allows clients to provide audio and video to a running conference in iChat AV. Video is provided by supplying a data source object to receive periodic callbacks for individual frames, and audio is provided through an audio device and channel. The state of the shared IMAVManager object allows clients to configure the user interface appropriately.

### Tasks

Tasks for creating an IMAVManager object include the task sharedAVManager that returns the shared instance of the IMAVManager object, creating it if the object doesn't exist yet.

Tasks for getting and setting properties tasks include: the task state that returns the current state of the receiver; the task videoDataSource that Returns the receiver's video data source object, and the task setVideoDataSource that sets the receiver's video data source object that provides video data to iChat AV.

Tasks for starting and stopping audio/video content include the task start that starts sending audio and video to iChat AV and the task stop that stops sending audio and video to iChat AV.

Tasks for Optimizing Audio/Video Performance include the task setVideoOptimizationOptions that sets the video optimization options and the task videoOptimizationOptions that returns the video optimization options.

Tasks for Managing Audio Channels include the task setNumberOfAudioChannels that sets the number of audio channels, the task numberOfAudioChannels that returns the number of audio channels; the task audioDeviceUlD that returns the audio device UID, and the task audioDeviceChannels that returns an array of audio device channel numbers used by the receiver.

### Class Methods

Class methods are methods that operate on a class, such as a method that returns an instance of a class. The class method “(IMAVManager*)sharedAVManger” returns the shared instance of the IMAVManager object, creating it if the object doesn't exist yet. The return value can be the shared IMAVManager object.

### Instance Methods

Instance methods are methods that operate on an instance, such as an object that is a member of a class. The instance method audioDeviceChannels returns an array of audio device channel numbers used by the receiver. The return value is an array of audio device channel numbers. If the number of audio channels is set to 2, then the first number in the array is the left channel and the second number is the right channel.

The instance method audioDeviceUlD returns the audio device UID. The return value is a valid UID when the receiver is in the IMAVRunning state. The device can be obtained by calling the AudioHardwareGetProperty function with the returned UID and the kAudioHardwarePropertyDeviceForUlD constant as arguments.

The instance method numberOfAudioChannels returns the number of audio channels and has a return value of the number of audio channels.

The instance method setNumberOfAudioChannels sets the number of audio channels and can include as parameters a count of the number of audio channels to configure. The allowed values may 0, 1, and 2. If 0, audio is disabled. If 1, audio is set to mono, and if 2, audio is stereo. The method can be used to set the number of audio channels that are configured after invoking start.

The instance method setVideoDataSource sets the receiver's video data source object that provides video data to iChat AV and can include as a parameter an object that conforms to the IMVideoDataSource informal protocol. The object can respond to either the renderIntoPixelBuffer:forTime and getPixelBufferPixelFormat: methods, or therenderIntoOpenGLBuffer:onScreen:forTime and getOpenGLBufferContext:pixelFormat: methods for OpenGL content. An NSView object can also be a video data source. The Instant Message framework adds video rendering capabilities to NSViewand all its subclasses. Passing nil can remove the receiver's video data source. The data source is not retained by the receiver.

The instance method setVideoOptimizationOptions sets the video optimization options and can include an options parameter that indicates the characteristics of the video content. Possible values are described in “IMVideoOptimizationOptions”. The method can be used to give hints to the receiver about the type of video content so it can optimize the CPU and bandwidth usage.

The instance method videoOptimizationOptions starts sending audio and video to iChat AV. The receiver's state changes to IMAVRunning, after possibly changing momentarily to IMAVStartingUp and IMAVPending. Before invoking this method, the video source can be set using the setVideoDataSource method to provide video content, or set the number of audio channels to greater than 0 using the setNumberOfAudioChannels method to provide audio content; otherwise, this method can raise an exception. This method can have no effect if invoked when the receiver is not in the IMAVStopped state.

The instance method state returns the current state of the receiver. The current state of the receiver set by iChat AV.

The instance method stop stops sending audio and video to iChat AV. After this method is invoked the state changes to IMAVStopped after possibly changing momentarily to IMAVShuttingDown.

The instance method videoDataSource returns the receiver's video data source object and can return the receiver's video data source, or nil if it is not set.

The instance method videoOptimizationOptions returns the video optimization options and can return video optimization options.

### Constants

The constants for IMAVManagerState can describe the state of an IMAVManager object, and can include enumeration values:

enum {
IMAVNotAvailable = 0,
IMAVStopped = 1,
IMAVShuttingDown = 2,
IMAVStartingUp = 3,
IMAVPending = 4,
IMAVRunning = 5
};

typedef NSUInteger IMAVManagerState;

IMAVNotAvailable can be used when an IMAVManager object is not available to send audio/video to iChat AV. IMAVStopped can be used when iChat AV is running and an IMAVManager object is available to send audio/video content to it. IMAVStartingUp can be used when an IMAVManager object is starting up and will soon change to the IMAVPending or IMAVRunning state.

IMAVPending can be used when iChat AV is not ready to receive content from an IMAVManager object. An IMAVManager object may enter this state after the start method is invoked when iChat AV is not ready to receive audio/video content. This state may be followed by IMAVRunning at any point. Typically, this state is entered if either the user does not yet have a video chat active or some internal processing or negotiation may need to take place before auxiliary audio/video input can begin. If the user does not have a video chat active, the state changes to IMAVRunning when a chat starts.

IMAVRunning can be used when an IMAVManager object is actively sending audio/video content to iChat AV. In some implementations it can be preferred not to send audio/video content to an IMAVManager object until it reaches this state, such immediately after sending start to the manager unless the manager is in this state. IMAVShuttingDown can be used when an IMAVManager object is shutting down and will soon change to the IMAVNotAvailable state.

The constants for IMVideoOptimizationOptions can include characteristics of the video source to allow for optimization of CPU and bandwidth usage:

enum {
IMVideoOptimizationDefault = 0,
IMVideoOptimizationStills = 1 << 0,
IMVideoOptimizationReplacement = 1 << 1,
};

typedef NSUInteger IMVideoOptimizationOptions;

IMVideoOptimizationDefault can be used when shared video is played alongside the user's local video, and the video is full-motion. This can be the default.

IMVideoOptimizationStills can be used when shared video remains unchanged for many sequential frames (such as a photo slideshow). This is a hint that the required bandwidth is lower than that of full-motion video. Incorrectly setting this option may result in poor video quality.

IMVideoOptimizationReplacement can be used when not sending the user's local video, instead devoting full CPU and bandwidth resources to the shared video.

### Notifications

IMAVManagerStateChangedNotification can be posted by the IMService class custom notification center when the iChat AV input state changes. The notification object can be the shared IMAVManager object. This notification may not have a user information dictionary. Observers of this notification can send the state to the shared IMService class.

The IMService class provides methods for getting information about an instant message service. Each IMService object represents one service available through the framework. Class methods such as allServices and serviceWithName: return these objects. Each object represents a single instant messaging service, allowing a user to access the iChat status of the user, the user's list of contacts, and other information that can be integrated into a user's application. A variety of status notifications related to the user's status and preferences are posted by the IMService custom notification center.

### Tasks

Tasks for Accessing Instant Messaging Services include the task allServices that returns an array of the currently available services and the task serviceWithName that returns the specified service.

Tasks for Accessing Service Attributes include: the task imageURLForStatus that returns the URL of the image for the specified status of a person, the task imageNameForStatus: that returns the name of the image for the specified status of a person, the task myldleTime that returns the number of seconds that the current user is idle, the task myStatus that returns the status of the current user, the task notificationCenter that returns the custom notification center for the service, the task localizedName that returns the user-visible localized name of the service, the task localizedShortName that returns a short version, if available, of the user-visible localized name of the service, the task name that returns the fixed canonical name of the service, and the task status that returns the login status of the service.

Tasks for Accessing Contacts includes: the task peopleWithScreenName that returns Address Book entries that match the specified screen name of a contact, the task screenNamesForPerson that returns an array of strings that are valid screen names for the specified person, the task infoForAllScreenNames that returns information about all contacts for the service, the task infoForPreferredScreenNames that returns information about just the preferred accounts for all contacts, and the task infoForScreenName: that returns information about a contact with the specified screen name.

### Class Methods

The class method allServices returns an array of the currently available services, and the return value can include an NSArray of IMService objects corresponding to the current available services (AIM, Bonjour, and so on.).

The class method imageNameForStatus returns the name of the image for the specified status of a person, can include a parameter for the status of a person, and cam return the name of an image that reflects the current online status of a person; it is usually a colored bubble or triangle.

The class method imageURLForStatus returns the URL of the image for the specified status of a person, can include the parameter of the status of a person, and can return an image that reflects the current online status of a person; the image is usually a colored bubble or triangle.

The class method myldleTime returns the number of seconds that the current user is idle and can have a return value of the number of seconds that the current user is idle.

The class method myStatus returns the status of the current user and can have a return value of a code representing the status of the current user. This status can be global across all services.

The class method notificationCenter can returns the custom notification center for the service and can have a return value of a custom notification center that manages IMService notifications.

The class method serviceWithName can return the specified service, can include a parameter of a service name as returned by a previous call to the name method, and can include a return value of the service specified by name.

### Instance Methods

The instance method infoForAllScreenNames returns information about all contacts for the service and can have a return value of dictionaries returned by infoForScreenName for all contacts. If the current user has multiple contacts for the same person (determined by the user'sAddress Book), this method can return the information for all of the accounts belonging to that person.

The instance method infoForPreferredScreenNames returns information about just the preferred accounts for all contacts and can have a return value of an array of the dictionaries returned by infoForScreenName for preferred accounts. If the current user has multiple contacts for the same person (determined by the user'sAddress Book), this method may return only the information for the preferred accounts belonging to that person. The preferred account can be determined by iChat, using a combination of capabilities (video chat capability, audio chat capability, and so on), status (available, idle, away), and other user attributes.

The instance method infoForScreenName returns information about a contact with the specified screen name, can have a parameter of a screen name for a contact, and can have a return value of information about a contact with the specified screen name.

The instance method localizedName returns the user-visible localized name of the service and can have a return value of the user-visible localized name of the service, such as “AOL Instant Messenger” or “Bonjour”.

The instance method localizedShortName returns a short version, if available, of the user-visible localized name of the service and can have a return value of the user-visible short localized name of the service, such as “AOL”.

The instance method name returns the fixed canonical name of the service and can have a return value of the fixed canonical name of the service. This string is not intended to be visible to the user and therefore is not localized.

The instance method peopleWithScreenName returns Address Book entries that match the specified screen name of a contact, can include a parameter of the screen name of a contact, and can have a return value of an array of Address Book entries that match the specified screen name of a contact. The instance method can return an empty array if there is no match.

The instance method screenNamesForPerson returns an array of strings that are valid screen names for the specified person, can include a parameter of a person entry in the Address Book, and can have a return value of an array of valid screen names for the specified person. Returns an empty array if there is no match.

The instance method status returns the login status of the service and can have a return value of the login status of the service.

### Constants

The constants for Screen Name Properties can describe keys for information about a person logged in to an instant message service-specifically, a contact that appears in the user's contact list:

extern NSString *IMPersonAVBusyKey;
extern NSString *IMPersonCapabilitiesKey;
extern NSString *IMPersonEmailKey;
extern NSString *IMPersonFirstNameKey;
extern NSString *IMPersonIdleSinceKey;
extern NSString *IMPersonLastNameKey;
extern NSString *IMPersonPictureDataKey;
extern NSString *IMPersonScreenNameKey;
extern NSString *IMPersonServiceNameKey;
extern NSString *IMPersonStatusKey;
extern NSString *IMPersonStatusMessageKey;

IMPersonAVBusyKey can be used to obtain a person's busy status. The value is an NSNumber set to 0 if the person's audio/video capabilities are available, or 1 if they are busy.

IMPersonCapabilitiesKey can be used to obtain a person's iChat capabilities. The value is an NSArray of capability properties.

IMPersonEmailKey can be used to obtain a person's email address. The value is an NSString containing the person's email address. This is a key used directly by Bonjour; however, if a person has an Address Book entry associated with a relevant AIM account, this key reflects the first email address of that person.

IMPersonFirstNameKey can be used to obtain a person's first name. The value is an NSString containing the person's first name. This is a key used directly by Bonjour; however, if a person has an Address Book entry associated with a relevant AIM account, this key reflects the first name of that person.

IMPersonIdleSinceKey can be used to obtain a person's idle status. The value is an NSDate containing the time, in seconds, since the last user activity. Available if the person's status is idle.

IMPersonLastNameKey can be used to obtain a person's last name. The value is an NSString containing the person's last name. This is a key used directly by Bonjour; however, if a person has an Address Book entry associated with a relevant AIM account, this key reflects the last name of that person.

IMPersonPictureDataKey can be used to obtain a person's image. The value is an NSData containing the image for the person's icon.

IMPersonScreenNameKey can be used to obtain a person's screen name. The value is an NSString containing the service-specific identifier for a person. For example, “User123” or “steve@mac.com” for AIM, and “John Doe” for Bonjour.

IMPersonServiceNameKey can be used to obtain a person's service name. The value is an NSString containing the name of the service this person belongs to.

IMPersonStatusKey can be used to obtain a person's online status. The value is an NSNumber representing the current online status of the person, if known.

IMPersonStatusMessageKey can be used to obtain a person's status message. The value is an NSString containing the person's current status message.

These keys can appear in the dictionary returned by the infoForScreenName method.

The constants for Person Capability Values can describe a person's iChat capabilities accessed using the IMPersonCapabilitiesKey key:

extern NSString *IMCapabilityAudioConference;
extern NSString *IMCapabilityDirectIM;
extern NSString *IMCapabilityFileSharing;
extern NSString *IMCapabilityFileTransfer;
extern NSString *IMCapabilityText;
extern NSString *IMCapabilityVideoConference;

IMCapabilityAudioConference can be used to specify that a person has audio chat capability. IMCapabilityDirectIM can be used to specify that a person has direct connect capability. IMCapabilityFileSharing can be used to specify that a person has file sharing capability. IMCapabilityFileTransfer can be used to specify that a person has file transfer capability. IMCapabilityText can be used to specify that a person has text capability. IMCapabilityVideoConference can be used to specify that a person has video chat capability.

The constants for IMServiceStatus can describe the states of a service:

enum {
IMServiceStatusLoggedOut,
IMServiceStatusDisconnected,
IMServiceStatusLoggingOut,
IMServiceStatusLoggingIn,
IMServiceStatusLoggedIn
};

typedef NSUInteger IMServiceStatus;

IMServiceStatusLoggedOut can be used to specify a service is currently logged out. IMServiceStatusDisconnected can be used to specify a service was disconnected, not by the user but by the system or because of an error. IMServiceStatusLoggingOut can be used to specify a service is in the process of logging out. IMServiceStatusLoggingIn can be used to specify a service is in the process of logging in. IMServiceStatusLoggedIn can be used to specify a service is currently logged in.

The constants for IMPersonStatus can describe the state of a person across all services:

enum {
IMPersonStatusUnknown,
IMPersonStatusOffline,
IMPersonStatusIdle,
IMPersonStatusAway,
IMPersonStatusAvailable,
#if MAC_OS_X_VERSION_MAX_ALLOWED >=
MAC_OS_X_VERSION_10_5
IMPersonStatusNoStatus
#endif
};

typedef NSUInteger IMPersonStatus;

IMPersonStatusUnknown can be used to specify that the person's status is unknown. IMPersonStatusOffline can be used to specify that the person is currently offline. IMPersonStatusIdle can be used to specify that the person is currently idle. IMPersonStatusAway can be used to specify that the person is currently away. IMPersonStatusAvailable can be used to specify that the person is currently available. IMPersonStatusNoStatus can be used to specify that no status is available. This can be accessed using the IMPersonStatusKey key for a contact or returned by the mystatus method for the current user.

### Notifications

IMPersonInfoChangedNotification can be posted by the IMService custom notification center when a screen name changes some aspect of its published information. The notification object is an IMService object. The user information dictionary can contain the IMPersonServiceNameKey key and may contain any of the other keys. If a particular attribute is removed, the value for the relevant key can be NSNull.

IMPersonStatusChangedNotification can be posted by the IMService custom notification center when a different contact (screen name) logs in, logs off, goes away, and so on. The notification object is an IMService object. The user information dictionary can contain the IMPersonServiceNameKey and IMPersonStatusKey keys, and optionally no others.

IMServiceStatusChangedNotification can be posted by the IMService custom notification center when the status of a service changes—the current user logs in, logs off, goes away, and so on. The notification object is an IMService object. The user information dictionary does not contain keys. The receiver should send status to the notification object to get the new service status.

IMStatusImagesChangedAppearanceNotification can be posted by the IMService custom notification center when the current user changes his or her preferred images for displaying status. The notification object is nil. This notification does not contain a user information dictionary. The imageNameForStatus method can be used to get the new images.

### Protocols

IMVideoDataSource is an informal protocol that an IMAVManager data source can typically conform to in order to provide video data to iChat AV.

To provide video when the CVPixelBuffer representation is preferred, the data source can implement both the getPixelBufferPixelFormat and renderIntoPixelBuffer:forTime methods. Otherwise, to provide video when the CVOpenGLBuffers representation is preferred, the data source can implement both the getOpenGLBufferContext:pixelFormat and renderIntoOpenGLBuffer:onScreen:forTime: methods.

### Tasks

Tasks for providing Pixel Buffered Video can include: task getPixelBufferPixelFormat that returns the pixel buffer format, and task renderIntoPixelBuffer:forTime that provides data for the next video frame using pixel buffering.

Tasks for Providing OpenGL Buffered Video can include: task getOpenGLBufferContext:pixelFormat that returns the pixel OpenGL buffer context and pixel format, and task renderIntoOpenGLBuffer:onScreen:forTime that provides data for the next video frame using OpenGL buffering.

### Instance Methods

Instance method getOpenGLBufferContext:pixelFormat returns the pixel OpenGL buffer context and pixel format can include: a contextOut parameter for the OpenGL context to be used for the CVOpenGLBufferRef instances passed to the renderIntoOpenGLBuffer:onScreen:forTime: method, and a pixelFormatOut parameter for the OpenGL pixel format to be used for the CVOpenGLBufferRef instances passed to the renderIntoOpenGLBuffer:onScreen:forTime: method. This method can be invoked once after setVideoDataSource is sent to an IMAVManager object.

Instance method getPixelBufferPixelFormat returns the pixel buffer format and can include a parameter pixelFormatOut for the pixel format to be used for the CVPixelBufferRef instances passed to the renderIntoPixelBuffer:forTime: method. This method can be invoked once after setVideoDataSource is sent to an IMAVManager object.

Instance method renderIntoOpenGLBuffer:onScreen:forTime provides data for the next video frame using OpenGL buffering and can include a buffer parameter for the OpenGL buffer to fill. The receiver should call the CVOpenGLBufferAttach function and then fill the buffer with video data. The method can also include a screenInOut parameter for the recommended virtual screen number to pass to the CVOpenGLBufferAttach function for maximum efficiency. The receiver may use a different screen number, but it can typically write that value back into screenInOut before returning. The method can also include a timestamp parameter for the frame time for which the buffer should be rendered. Rendering can typically be for a video frame that corresponds to the supplied host time, timeStamp->hostTime, and before returning from this method, change the host time to the earliest time for which the rendered video is valid. For example, if the content is a movie, then set the host time to correspond to the rendered frame—typically, slightly earlier than the original host time. If the content is a photo slideshow, then set the host time to the time the image first appeared which can be several seconds before the original host time. Adjusting the time this way helps synchronize the audio with the video track. The method can have a return value that returns YES if the buffer is successfully filled with new frame data, or NO if nothing changed or an error was encountered. This method can be invoked each time a frame is sent to iChat AV. In some implementations, this method may not be invokable on the main thread.

Instance method renderIntoPixelBuffer:forTime provides data for the next video frame using pixel buffering and can include parameters buffer and timestamp. Buffer can be the pixel buffer to fill with video data. The dimensions can vary. CVPixelBufferGetWidth and CVPixelBufferGetHeight functions can be used to get the dimensions each time this method is invoked. Parameter timestamp can be the frame time for which the buffer should be rendered. Rendering can typically render a video frame that corresponds to the supplied host time, timeStamp->hostTime, and before returning from this method, change the host time to the earliest time for which the rendered video is valid. For example, if the content is a movie, then set the host time to correspond to the rendered frame—typically, slightly earlier than the original host time. If the content is a photo slideshow, then set the host time to the time the image first appeared which can be several seconds before the original host time. Adjusting the time this way helps synchronize the audio with the video track. The method's return value can return YES if the buffer is successfully filled with new frame data, or NO if nothing changed or an error was encountered. This method can be invoked each time a frame is sent to iChat AV. This method is not invoked on the main thread.

FIG. 5 is a diagram of an electronic communication system architecture 500. The architecture 500 can be used to support the electronic communications framework used in rendering, for example, the electronic communications depicted in FIGS. 1-3. The architecture 500 includes an operating system 502, graphics and media subsystems 504, frameworks 506, user interface facilities 508, and applications 510-514.

The operating system 502 can be based on Mac OS X or any suitable operating system. Mac OS X is a uniquely powerful development platform, supporting multiple development technologies including UNIX, Java, the proprietary Cocoa and Carbon runtime environments, and a host of open source, web, scripting, database, and development technologies. Built around the integrated stack of graphics and media technologies including Core Image, Core Video, Core Audio and QuickTime, Mac OS X provides a solid foundation for developers to create great applications. Mac OS X Tiger also offers powerful user technologies like Spotlight and Dashboard that can be exploited by developers in their applications.

The operating system 502 can use Darwin or other such UNIX-based foundation. Darwin is described in detail below.

The graphics and media subsystems 504 can include components such as QuickTime, Core Audio, Core Image, Core Video and OpenGL, each of which is described below. Graphics and media subsystems 504 can also include other components not listed here.

Frameworks 506 includes an electronic communications framework 516. The framework 516 can include the tasks, method, constants and notifications described in detail above in reference to FIGS. 1-3 and the flow diagram of FIG. 4. Such an electronic communications framework 516 can be used, for example, to facilitate the electronic communications depicted in FIGS. 1-3.

Frameworks 506 also includes components such as Cocoa, Carbon and Java, each of which is described below. Frameworks 506 can also include other components not listed here.

The functionality, services and operations provided by the frameworks 506 and specifically the electronic communications framework 516 may be accessible and usable by the APIs of various applications, such as applications 510-514. For example, the frameworks 506 and 516 may be used by an API 518 of the iChat application 510.

User interface facilities 508 can include components such as Aqua, Dashboard, Spotlight and Accessibility, each of which is described below. User interface facilities 508 can also include other components not listed here.

Aqua is the overall appearance and behavior of Mac OS X. Aqua defines the standard appearance of specific user interface components such as windows, menus, and controls. It uses high-quality graphics and user-centric design to produce a user experience that is both functional and appealing.

Dashboard is a display and management system for Mac OS X desktop utilities, called widgets. Developers can create widgets, such as a clock or a calculator, to provide functionality that may not require the complexity of a large application.

Spotlight provides a new way of organizing and accessing information in on a user's computer by using metadata. Metadata can include familiar information such as an asset's modification date and author but it can also include keywords or other information that is custom to a particular asset. Spotlight can use this information to allow a user to find all their files or references to any particular keyword or set of terms.

Accessibility refers to programming interfaces that support the development of accessible applications and assistive technologies and applications, which help make the Macintosh accessible to all users. An assistive application interacts with an application's user interface to provide an alternative way for persons with disabilities to use the application.

Cocoa is an object-oriented application environment designed specifically for developing Mac OS X native applications. The Cocoa frameworks support rapid development and high productivity, and include a full-featured set of classes designed to create robust and powerful Mac OS X applications.

Carbon is a set of APIs that enables C and C++ developers to take advantage of Mac OS X-specific features, including an advanced user interface tool kit, an efficient event-handling mechanism, the Quartz 2D graphics library, and multiprocessing support. In addition, other industry-standard C and C++APIs are easily available to Carbon developers, providing access to such services as the OpenGL drawing system, the Mach microkernel, and BSD operating-system services.

Java support in Mac OS X is built around the foundation of the Java 2, Standard Edition implementation, which is installed with every copy of Mac OS X and Mac OS X Server. Java developers can easily distribute their cross-platform J2SE applications as native Mac OS X applications, or they can take advantage of Mac OS X-specific Java versions of some Cocoa APIs.

QuickTime is Apple's cross-platform multimedia technology for creating and delivering video, sound, animation, graphics, text, interactivity, and music. QuickTime supports dozens of file and compression formats for images, video, and audio, including ISO-compliant MPEG-4 video and AAC audio. QuickTime applications can run on Mac OS X and all major versions of Microsoft Windows.

Core Audio refers to system-level services in Mac OS X that streamline the development process for audio developers and for all application developers who want to incorporate audio into their products. Core Audio provides native, state-of-the-art, multichannel audio in a manner scalable for future high-resolution formats. The Audio Unit API provides a plug-in architecture for both DSP and for MIDI-based instruments.

Core Image is an image processing technology built into Mac OS X v10.4 that leverages programmable graphics hardware whenever possible. The Core Image application programming interface (API) provides access to built-in image filters for both video and still images and provides support for custom filters and near real-time processing.

Video is essentially a timed sequence of images. Various QuickTime interfaces make it easy to capture and display video on Mac OS X. Core Video provides an easy way to obtain frames from any video source and provides the opportunity to filter or transform them using Core Image or OpenGL.

Mac OS X features a highly optimized and fully modern implementation of OpenGL. OpenGL is the industry standard for high performance 2D and 3D graphics, and is the primary gateway to the Graphics Processing Unit (GPU). OpenGL is specifically designed to support the rich graphics needs of scientific visualization, medical imaging, CAD/CAM, and entertainment software.

Darwin is the open source UNIX-based foundation of Mac OS X. Darwin integrates a number of technologies. Among the most important are the Mach 3.0 microkernel operating-system services, based on 4.4BSD (Berkeley Software Distribution), the high-performance networking facilities, and the support for multiple integrated file systems. Darwin also includes a number of command-line tools. Mac OS X developers can use Darwin to port UNIX/Linux applications and to create kernel extensions.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-readable medium having instructions stored thereon, which, when executed by a processor, causes the processor to perform operations comprising:
running one or more applications;
receiving from at least one running application a request for communication services; and
responsive to the request, providing the requested services to the application.

2. The computer-readable medium of claim 1, wherein receiving a request further comprises:
receiving one or more parameters from the requesting application for use by the services.

3. The computer-readable medium of claim 1, wherein providing the requested services further comprises:
providing information to the application.
